(19) United States
(12) Patent Application Publication
(10) Pub. No.: US 2015/0099118 A1
(43) Pub. Date: Apr. 9, 2015

(54) METAL-AIR BATTERIES AND ELECTRODES THEREFORE UTILIZING METAL NANOPARTICLE SYNTHESIZED VIA A NOVEL MECHANICOCHEMICAL ROUTE

(71) Applicant: Toyota Motor Engineering & Manufacturing North America, Inc., Erlanger, KY (US)

(72) Inventors: Fuminori Mizuno, Ann Arbor, MI (US); Michael Paul Rowe, Pinckney, MI (US); Ryan Daniel Desautels, Winnipeg (CA)

(21) Appl. No.: 14/307,017

(22) Filed: Jun. 17, 2014

Related U.S. Application Data
(63) Continuation-in-part of application No. 14/046,081, filed on Oct. 4, 2013.
Application No. 14/046,081 is a continuation-in-part of application No. 14/046,120, filed on Oct. 4, 2013.
Application No. 14/046,120 is a continuation-in-part of application No. 14/219,836, filed on Mar. 19, 2014.
Application No. 14/219,836 is a continuation-in-part of application No. 14/269,895, filed on May 5, 2014.

(51) Int. Cl. H01M 4/92; H01M 4/88; H01M 12/08; B22F 9/18

(52) U.S. Cl. CPC H01M 4/926; B22F 9/18; H01M 4/8857; H01M 12/08; H01M 2004/8689
USPC 428/402; 75/343; 75/354; 75/247

(57) ABSTRACT

Electrodes for metal-air batteries and the metal-air batteries employing such electrodes are provided. The electrodes include metal nanoparticles synthesized via a novel route. The nanoparticle synthesis is facile and reproducible, and provides metal nanoparticles of very small dimension and high purity for a wide range of metals. The electrodes utilizing these nanoparticles thus may have superior capability. Electrochemical cells employing said electrodes are also provided.

### CROSS-REFERENCE TO RELATED APPLICATIONS

This application is a continuation-in-part of application Ser. Nos. 14/046,081 and 14/046,120, filed 4 Oct. 2013, a continuation-in-part of application Ser. No. 14/219,836, filed 19 Mar. 2014, a continuation-in-part of application Ser. No. 14/269,895, filed 5 May 2014, each of which is herein incorporated by reference in its entirety.

### TECHNICAL FIELD

The present invention relates in general to an electrode having metal nanoparticles synthesized by a novel route, and to an electrochemical cell bearing such an electrode.

### BACKGROUND

Metal-air battery has gained more and more attention as one of the post lithium-ion battery technologies. This is ideally supported by the concept that O₂ gas as an active material is continuously coming from outside of the battery.

Currently, Li-air battery is a promising candidate of high energy density type rechargeable batteries, because the most negative potential of Li metal brings about the highest working potential. The Li anode still has the serious problems of dendrite growth and high moisture reactivity. However, because of such a high working voltage, this battery technology is of significant interest in post lithium-ion batteries.

On the other hand, this system has many issues on the cathode side as well. The cathode in Li-air batteries requires an oxygen reduction reaction associated with the Li ion during discharging, and the subsequent decomposition reaction of Li compounds (such as Li₂O₂, LiOH and Li₂CO₃ as discharge products) during recharging. In particular, carbon as a conducting support has been recently reported to be corroded during recharging, resulting in generation of unwanted CO₂ gas, and the accumulation of insulative/resistive carbonates. In terms of battery performance, these accumulation processes cause poor rechargeability, rate capability and cycleability of lithium-air batteries.

One of the countermeasures to avoid carbon corrosion is to replace carbon with non-carbon materials such as ceramics and metal. Bruce et al. demonstrated a version of this strategy with nanoporous gold and TiC ceramic as alternatives carbon cathode. By applying this idea to non-aqueous Li-air batteries, carbon corrosion was remarkably suppressed, and battery performance was drastically improved. Therefore, non-carbon materials are of great interest in this research field.

One of the issues for carbon cathode alternatives is the low surface area of non-carbon materials. Carbon is often used as porous materials with high surface area because it works well at practically high rates. Considering cost, mass production and quality, developing non-carbon materials with high surface area is a big challenge. Therefore, non-carbon materials with high surface area are strongly desired.

### SUMMARY

Electrodes and electrochemical cell employing metal nanoparticles synthesized by a novel route are provided.

In one aspect, an electrode for a metal-air battery comprising metal nanoparticles is disclosed, wherein the metal nanoparticles are synthesized by a method comprising adding surfactant to a reagent complex according to Formula I:

M⁰.Xy I,

wherein M⁰ is zero-valent metal, X is a hydride, and y is an integral or fractional value greater than zero.

In another aspect, a metal-air battery is disclosed. The metal-air battery has an electrode, the electrode comprising metal nanoparticles, the metal nanoparticles having been synthesized by a method comprising adding surfactant to a reagent complex according to Formula I:

M⁰.Xy I,

wherein M⁰ is zero-valent metal, X is a hydride, and y is an integral or fractional value greater than zero.

### BRIEF DESCRIPTION OF THE DRAWINGS

Various aspects and advantages of the invention will become apparent and more readily appreciated from the following description of the embodiments taken in conjunction with the accompanying drawings, of which:

FIG. 1 is an x-ray photoelectron spectrum of an Ag.(LiBH₄)₂ complex prepared by the process reported here;

FIG. 2 is an x-ray diffraction spectrum of silver nanoparticles synthesized by a disclosed process using the Ag.(LiBH₄)₂ complex of FIG. 1;

FIG. 3 is a plot of voltage vs. logarithm of current density for three lithium-air batteries having cathodes with different forms of silver;

FIG. 4 is a plot of voltage vs. capacity for four lithium-air batteries; and

FIG. 5 is a plot of voltage vs. logarigthm of current density for two lithium-air batteries, where carbon powder is incorporated in the cathodes.

### DETAILED DESCRIPTION

The present disclosure describes electrodes for use in metal-air batteries, as well as the metal-air batteries which include an electrode of the type disclosed. The electrodes include metal nanoparticles synthesized by a novel mechanochemical synthetic technique. The metal nanoparticles which are included in the electrode can be of any metal. In addition, the metal nanoparticles included in the disclosed electrodes are easily producible at industrial scale, at uniform size down to low nanometer, and are highly pure, for example being devoid of oxides.

As shown below, the metal-air batteries and electrodes of the present disclosure demonstrate superior performance as compared to similar system which, instead of metal nanoparticles synthesized by the disclosed novel method, employ macroscale metal, microscale metal, or commercially available nanoparticulate metal.

An electrode for use in a metal-air battery is disclosed. The electrode includes zero-valent metal nanoparticles, where the term “zero-valent” means that the metal nanoparticles consist essentially of metal which is in oxidation state zero, or elemental metal. The zero-valent metal nanoparticles included in the electrode, referred to henceforth simply as “metal nanoparticles” can be prepared by a disclosed method for synthesizing metal nanoparticles which includes a step of contacting a reagent complex with a surfactant. The reagent complex used in the method for synthesizing metal nanoparticles has a formula according to Formula I:

M⁰.X_{y} I,

wherein M⁰ is a zero-valent metal and X is a hydride. The subscript y can be any positive fractional or integral value. In some cases, y can be a value from 1 to 4, inclusive. In some cases, y can be a value from 1 to 2, inclusive. In some cases, y will be approximately 2.

The zero-valent metal can be any transition metal, post-transition metal, alkali metal, or alkaline earth metal. In some instances, the zero-valent metal can be a noble metal. In one non-limiting example discussed below, the zero-valent metal is silver

The hydride employed in Formula I can be a solid metal hydride (e.g. NaH, or MH₂), metalloid hydride (e.g. BH₃), complex metal hydride (e.g. LiAlH₄), or salt metalloid hydride also referred to as a salt hydride (e.g. LiBH₄). In some examples the hydride will be LiBH₄, yielding a reagent complex having the formula M.LiBH₄. In some specific examples, the reagent complex will have the formula M.(LiBH₄)₂. It is to be appreciated that the term hydride as used herein can also encompass a corresponding deuteride or tritide.

The reagent complex can be a complex of individual molecular entities, such as a single metal atom in oxidation state zero in complex with one or more hydride molecules. Alternatively the complex described by Formula I can exist as a molecular cluster, such as a cluster of metal atoms in oxidation state zero interspersed with hydride molecules, or a cluster of metal atoms in oxidation state zero, the cluster surface-coated with hydride molecules or the salt hydride interspersed throughout the cluster.

One process by which a reagent complex according to Formula I can be obtained includes a step of ball-milling a mixture which includes both a hydride and a preparation composed of metal. The preparation composed of metal can be any source of metallic metal, but will typically be a source of metallic metal which contains zero-valent metal at greater than 50% purity and at a high surface-area-to-mass ratio. For example, a suitable preparation composed of metal would be a metal powder comparable to commercial grade metal powder.

The ball-milling step can be performed with any type of ball mill, such as a planetary ball mill, and with any type of ball-milling media, such as stainless steel beads. It will typically be preferable to perform the ball-milling step in an inert environment, such as in a glove box under vacuum or under argon.

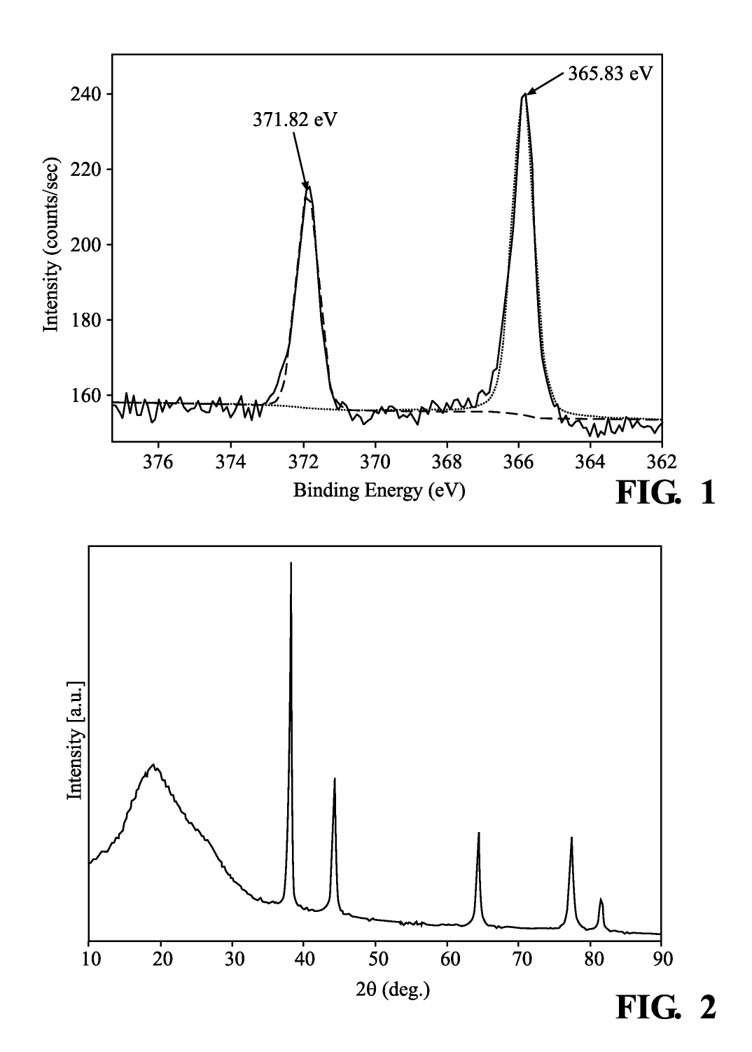

An x-ray photoelectron spectrum of an example reagent complex, Ag.(LiBH₄)₂, obtained by this process is shown in FIG. 1. An x-ray diffraction spectrum of the silver nanoparticles synthesized by addition of surfactant to this reagent is shown in FIG. 2.

In some variations of the method for synthesizing metal nanoparticles, the surfactant can be in suspended or solvated contact with a solvent or solvent system. In different variations wherein the reagent complex is in suspended contact with a solvent or solvent system and the surfactant is suspended or dissolved in a solvent or solvent system, the reagent complex can be in suspended contact with a solvent or solvent system of the same or different composition as compared to the solvent or solvent system in which the surfactant is dissolved or suspended.

In some variations of the method for synthesizing metal nanoparticles, the reagent complex can be combined with surfactant in the absence of solvent. In some such cases a solvent or solvent system can be added subsequent to such combination. In other aspects, surfactant which is not suspended or dissolved in a solvent or solvent system can be added to a reagent complex which is in suspended contact with a solvent or solvent system. In yet other aspects, surfactant which is suspended or dissolved in a solvent or solvent system can be added to a reagent complex which is not in suspended contact with a solvent or solvent system.

The surfactant utilized in the method for synthesizing metal nanoparticles can be any known in the art. Usable surfactants can include nonionic, cationic, anionic, amphoteric, zwitterionic, and polymeric surfactants and combinations thereof. Such surfactants typically have a lipophilic moiety that is hydrocarbon based, organosilane based, or fluorocarbon based. Without implying limitation, examples of types of surfactants which can be suitable include alkyl sulfates and sulfonates, petroleum and lignin sulfonates, phosphate esters, sulfosuccinate esters, carboxylates, alcohols, ethoxylated alcohols and alkylphenols, fatty acid esters, ethoxylated acids, alkanolamides, ethoxylated amines, amine oxides, alkyl amines, nitriles, quaternary ammonium salts, carboxybetaines, sulfobetaines, or polymeric surfactants.

In some instances the surfactant employed in the method for synthesizing metal nanoparticles will be one capable of oxidizing, protonating, or otherwise covalently modifying the hydride incorporated in the reagent complex. In some variations the surfactant can be a carboxylate, nitrile, or amine. In some examples the surfactant can be octylamine.

The metal nanoparticles included in the electrode can have an average maximum dimension less than 100 nm. In some instances, the metal nanoparticles included in the electrode have an average maximum dimension less than 25 nm. In some instances, the metal nanoparticles included in the electrode have an average maximum dimension less than 10 nm. In some instances, the metal nanoparticles included in the electrode have an average maximum dimension of 5 nm or less. The metal nanoparticles included in the electrode are, in some variations, generally of uniform size and free of oxide. The metal nanoparticles included in the electrode can be obtained by the process for synthesizing metal nanoparticles, as disclosed above.

It will be appreciated that the disclosed electrode can, and frequently will, include additional structural and/or electrochemically active materials. For example, polytetrafluoroethylene (PTFE) can serve as a binder to facilitate metal nanoparticle dispersion, adhesion, or structural integrity. The disclosed electrode can include a substance such as carbon powder or carbon paper, to participate in electrochemistry or to serve as a structural substrate. It is to be understood that these are examples only, and that any suitable materials can be incorporated into the disclosed electrode along with the metal nanoparticles.

Thus, in one non-limiting example, discussed further below, an example electrode according to the present disclosure includes silver nanoparticles, obtained by the disclosed process for synthesizing metal nanoparticles. The silver nanoparticles are mixed with poly(vinylidene fluoride-co-hexafluoropropene) (PVdF-HFP) and (N,N-diethyl-N-(2-methoxyethyl)-N-methylammonium bis(trifluoromethylsulphonyl-imide) (DEME-TFSI) in N-methylpyrrolidone (NMP) and the mixture is cast on carbon paper.

Further disclosed is a metal-air battery having at least one electrode of the type described above. The metal-air battery will generally produce an electrical current via an electrochemical reaction in which a cation species originated from a metal anode reacts with oxygen through electron reduction or oxidation process. In some instances, the metal-air battery will be a lithium-air battery, in which electrical current is generated by an electrochemical reaction which includes the following: within which occurs during normal operation at least the following electrochemical reaction:

2Li⁺+2e⁻+O₂ [symbol] Li₂O₂.

In some instances, the electrode as described above and included within the metal-air battery of the present disclosure will operate as a cathode-type electrode during discharge and charge.

In a non-limiting example (details of which are provided below), a lithium-air battery was prepared having a lithium anode and lithium bis(trifluoromethanesulfonyl)Imide (LiTFSI) dissolved in DEME-TFSI as an electrolyte. Six similar batteries were prepared in which the cathode had the silver nanoparticles of FIG. 2 (Example 1), μm scale commercially available silver particles (Comparative Example 1), nm scale commercially available silver nanoparticles (Comparative Example 2), no silver (Comparative Example 3), the commercial silver nanoparticles of Comparative Example 2, in admixture with carbon powder (Comparative Example 4), or the silver nanoparticles of Example 1 in admixture with carbon powder (Comparative Example 5).

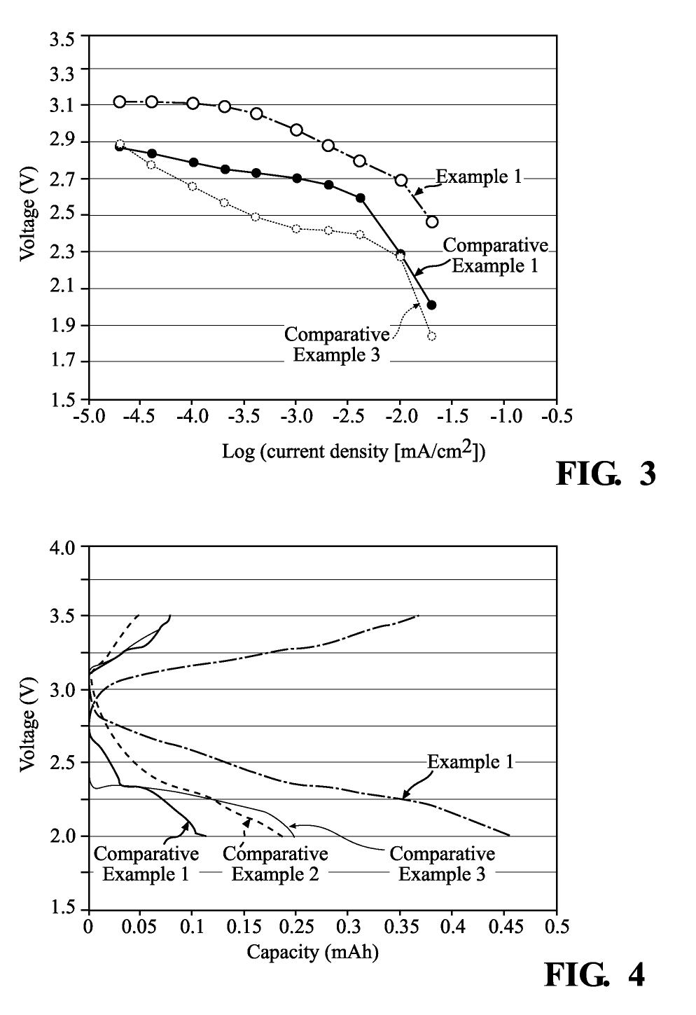

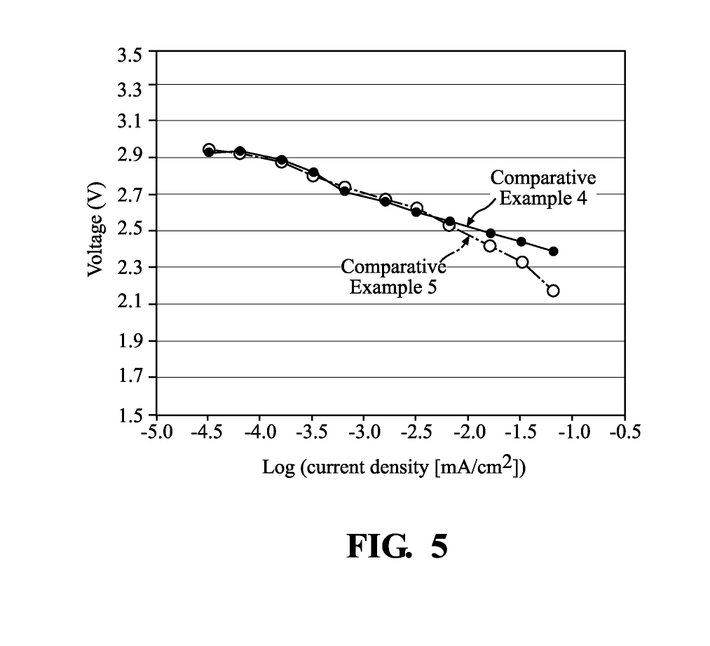

The plot in FIG. 3 showing battery voltage as a function of the logarithm of current density demonstrates the superiority of the battery of the present disclosure as compared to the comparable batteries having commercially available silver particles on the cathode. The plot of initial charge/discharge profiles in FIG. 4 further indicates the superior charge/discharge properties of the battery according to the present disclosure. Finally, the current-voltage profiles of FIG. 5, again represented by voltage as a function of logarithm of current density, indicate that the battery according to the present disclosure has superior performance when carbon is omitted from the cathode.

Various aspects of the present disclosure are further illustrated with respect to the following Examples. It is to be understood that these Examples are provided to illustrate specific embodiments of the present disclosure and should not be construed as limiting the scope of the present disclosure in or to any particular aspect.

In each of the examples below, an electrode is prepared as described, and then incorporated into a lithium-air battery opposite a lithium anode with 0.352 mol/kg LiTFSI in DEMETFSI which is immersed in glass filter separator (Whattman) and the battery is supplied with pure oxygen (99.99% in purity). The battery is a coin-type cell with air hole toward cathode side which is put in gas tight chamber.

A current was applied for 30 minutes and the potential was monitored. After 30 minute, the current was switched next in the range of 0.1 μA-1 mA. In FIGS. 3 and 5, the potentials recorded after 30 minute were plotted as a function of logarithm of current density. For discharge-charge measurements, the current of 53 μA was applied and the cut-off voltage was 2.0 V and 3.5 V, respectively.

### Example 1

### Electrode Having Silver Nanoparticles Synthesized by the Disclosed Method

Silver powder (6.00 g) and lithium borohydride (2.44 g) are combined in a planetary ball mill. The combination is ball-milled for 4 hours at 160 rpm with stainless steel ball bearings. This produced particles of Ag.(LiBH₄)₂ complex, an XPS spectrum of which is shown in FIG. 1. The reagent complex (5.58 g) is suspended in THF (100 mL) and octylamine (47.7 g) is added, and stirred for 4 hours to produce silver nanoparticles (XRD spectrum shown in FIG. 2). These silver nanoparticles were then washed with additional THF.

Ag nanoparticles obtained by the mechanochemical process above are mixed with PVdF-HFP (Alkema) and DEMETFSI ionic liquid (Kanto corporation) in the NMP (Aldrich) solvent, and then was cast on a carbon paper (Toray, TGP-H-60), and finally dried at 120° C. under vacuum. The weight ratio of Ag:PVdF-HFP:DEMETFSI to form an electrode was 30:15:55 (wt %).

### Comparative Example 1

An electrode is compared as in Example 1, however commercially available μm scale Ag particles are used in place of the nanoparticles prepared by the mechanochemical method.

### Comparative Example 2

An electrode is compared as in Example 1, however commercially available nanoparticulate Ag is used in place of the nanoparticles prepared by the mechanochemical method.

### Comparative Example 3

An electrode is prepared as above, however no silver is used; carbon paper only (No Ag particle).

### Comparative Example 4

An electrode is prepared as in Comparative example 1, except that Super P carbon black is included in the material cast on carbon paper. SuperP:Ag:PVdF-HFP:DEMETFSI=11:19:15:55 (wt %).

### Comparative Example 5

An electrode is prepared as in Example 1, except that Super P carbon black is included in the material cast on carbon paper. SuperP:Ag:PVdF-HFP:DEMETFSI=11:19:15:55 (wt %).

The foregoing description relates to what are presently considered to be the most practical embodiments. It is to be understood, however, that the disclosure is not to be limited to these embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. An electrode for a metal-air battery comprising metal nanoparticles, the metal nanoparticles synthesized by a method comprising:
adding surfactant to a reagent complex according to Formula I,
M⁰.X_{y} I,
wherein M⁰ is zero-valent metal, X is a hydride, and y is an integral or fractional value greater than zero.

2. The electrode of claim 1 wherein the reagent complex is obtained by a process that includes a step of:
ball milling a mixture that includes a hydride and a preparation composed of metal.

3. The electrode of claim 1 wherein the hydride is lithium borohydride.

4. The electrode of claim 1 wherein the metal nanoparticles have an average maximum dimension less than 25 nm.

5. The electrode of claim 1 wherein the metal nanoparticles have an average maximum dimension less than 10 nm.

6. The electrode of claim 1 wherein the zero-valent metal is noble metal.

7. The electrode of claim 1 wherein the zero-valent metal is silver.

8. A metal-air battery having an electrode, the electrode comprising metal nanoparticles, the metal nanoparticles having been synthesized by a method comprising:
adding surfactant to a reagent complex according to Formula I,
M⁰.X_{y} I,
wherein M⁰ is zero-valent metal, X is a hydride, and y is an integral or fractional value greater than zero.

9. The metal-air battery of claim 8 wherein the metal nanoparticles have an average maximum dimension less than about 10 nm.

10. The metal-air battery of claim 8 wherein the metal nanoparticles are noble metal nanoparticles.

11. The metal-air battery of claim 8 wherein the metal nanoparticles are silver nanoparticles.

12. The metal-air battery of claim 8 which is a lithium-air battery.
